(19) United States
(12) Patent Application Publication
(10) Pub. No.: US 2016/0202760 A1
(43) Pub. Date: Jul. 14, 2016

(54) SYSTEMS AND METHODS FOR CONTROLLING FEEDBACK FOR MULTIPLE HAPTIC ZONES

(71) Applicant: Microsoft Technology Licensing LLC, Redmond, WA (US)

(72) Inventors: Anatoly Churikov, Bellevue, WA (US); Catherine Boulanger, Redmond, WA (US); Tristan Trutna, Seattle, WA (US); Nigel Keam, Redmond, WA (US); Steven Bathiche, Kirkland, WA (US); Luis Cabrera-Cordon, Bothell, WA (US); Carl Picciotto, Redmond, WA (US)

(21) Appl. No.: 14/298,658

(22) Filed: Jun. 6, 2014

(51) Int. Cl. G06F 3/01; G06F 3/041

(52) U.S. Cl. CPC G06F 3/016; G06F 3/0416

(57) ABSTRACT

Systems and methods for creating multiple haptic zone responses for electronic devices are disclosed. Suitable electronic devices are embedded with a number of haptic elements that are spaced along the surface of the device. In one aspect, the number of haptic elements is sufficient to have at least one haptic element proximal in a grip zone of a user. During operation, the device may receive user interaction information (e.g., user location, pressure etc.) and indications to deliver a haptic response to the user, possibly depending on the execution of an application where haptic response is appropriate. The device determines a desirable number of haptic elements to energize depending upon the user interaction information and the set of haptic elements define a dynamic set of user interaction zones in which to deliver the haptic response.

### BACKGROUND

Vibro-tactile haptics technology are found in a wide number of currently-available consumer electronic devices—e.g., such as tablets, smart devices, game controllers, smart phones and/or mobile phones—that provide a rumble feedback in silent mode for a phone, feedback from a fixed sensor button for a touch screen, or for improving a gaming experience by providing specific feedback on a gamepad/game controller that is correlated to what may be happening on a screen.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods for creating multiple haptic zone responses for electronic devices are disclosed. Suitable electronic devices are embedded with a number of haptic elements that are spaced along the surface of the device. In one aspect, the number of haptic elements is sufficient to have at least one haptic element proximal in a grip zone of a user. During operation, the device may receive user interaction information (e.g., user location, pressure etc.) and indications to deliver a haptic response to the user, possibly depending on the execution of an application where haptic response is appropriate. The device determines a desirable number of haptic elements to energize depending upon the user interaction information and the set of haptic elements define a dynamic set of user interaction zones in which to deliver the haptic response.

In one embodiment, an electronic device is disclosed, comprising: a housing, the housing comprising a surface, said housing capable of being held by a user at said surface; a plurality of haptic elements, said haptic elements screen mated to said housing along said surface, said haptic elements being spaced along said surface to allow a desired set of user interaction zones to be dynamically defined; said plurality of haptic elements being in communication with a processor, said processor configured, by reading instructions stored on a computer-readable storage media, to: receive user interaction information; receive indications to deliver a haptic response to said user; determine an desired haptic response to said user, based upon said haptic response indications; and determine a desired number of haptic elements to energize to provide said desired haptic response, based upon said user interaction information and said desired number of haptic elements defining a set of user interaction zones to deliver said haptic response.

In another embodiment, a method for energizing a desired set of haptic elements is disclosed, where said haptic elements embedded in an electronic device along the surface of the electronic device and creating a set of dynamically generated user interaction zones, comprising: executing an application capable of employing haptic feedback to a user; determining a desired haptic response upon receipt of an indication to deliver a haptic response to the user; determining user interaction information; and dynamically determining a set of haptic elements to energize with desired haptic response signals, based on said user interaction information, said set of energized haptic elements defining a set of user interaction zones.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is one embodiment of an exemplary device comprising a ambient multiple haptic zones, as made in accordance with the principles of the present application.

FIG. 1B is a conceptual drawing of a computer device that may be incorporated into the device of FIG. 1A.

FIG. 2 depicts a gaming example comprising a game in which the haptic elements may assume different feedback intensity levels and/or be partitioned into zones.

FIGS. 3 and 4 depict other gaming examples as made in accordance with the principles of the present application.

FIG. 5 is a top, cut-through view of the handheld device as depicted in FIG. 4.

FIGS. 6A and 6B depict a haptic response given to two different user scrolling gestures, one large and one relatively small, respectively.

FIGS. 7A and 7B depict examples of a user's touch screen gesture being appropriately modeled by haptic elements.

FIGS. 8A, 8B and 8C show one exemplary tablet/laptop device having the haptic elements that border the device.

FIG. 9 is a side, cut view of a tablet/laptop that shows one possible mechanical design/arrangement of haptic elements mated to the device.

FIG. 10 depicts one example of a tablet/laptop that may employ a keyboard that comprises haptic elements that border the keyboard.

FIGS. 11A and 11B depict examples in which a detachable keyboard 1100 may employ haptic elements.

FIGS. 12A, 12B, and 13 depict the placement of haptic elements on other I/O devices—a controller, a mouse, and a stylus pen, respectively.

FIGS. 14A and B, 15A and B and 16A and B depict different haptic zone placements on a smart device, on front views and side, cross-section views respectively.

FIGS. 17A and B are a front view and perspective view of a mouse with different haptic zones, respectively.

FIG. 18 is a side, cross-section view of a device employing vertical haptic sensation isolation.

FIG. 19 is a partial front view of a device employing horizontal haptic sensation isolation.

FIGS. 20A and B are a front view and rear view respectively of a game controller with different haptic zones.

FIGS. 21A and B show side views of a smart device with a keyboard that is deployed for typing and fold back for holding, respectively.

FIG. 22 is one flowchart embodiment for the operation of a device that has haptic elements attached and/or mated to the device as made in accordance with the principles of the present application.

FIG. 23 is a flowchart embodiment of a process for delivering a haptic response to a reduced number of haptic elements based on the user's interaction with the device.

FIG. 24 is one flowchart embodiment for a process of generating and/or creating and sending haptic information/response when a game/video data stream is presented to a user(s).

FIG. 25 is a flowchart embodiment of a process for providing haptic response/information during a game playback.

FIG. 26 is a flowchart embodiment of a process for generating haptic responses for scrolling commands upon a touch enabled device.

FIG. 27 is a flowchart embodiment of a process for generating haptic responses for the side gestures.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Devices may employ global haptic feedback—e.g., a single actuator (e.g., Eccentric Rotating Mass (ERM), Linear Resonant Actuator (LRA) and/or a Piezo structure) integrated to the mobile device. Other haptic actuators may also comprise electro-active polymers, electromechanical polymers, piezo discs and piezo unimorph and bimorph bars. Such actuators may provide a rumble-like feedback and may be felt almost equally at all sides of the device. Such an approach brings a good “user experience” (UX) when a device provides a “global system feedback” for such events—e.g., such as incoming call event or open/close application.

A device may include specific zones with different feedbacks separated from each other. In these devices, a number of haptic structures are arrayed upon, embedded in and/or otherwise mated to the device. These haptic structures further comprise multiple haptic zones to provide users a rich haptic experience. These haptic zones may work either independently of each other or may work cooperatively with each other—e.g., depending upon the desired haptic effect that is intended to give the user. How multiple zones work and/or interact with each other may also be dependent upon the given application that is executing or the audio/visual data being displayed to the user.

Multiple haptic zone feedback may be embedded, mated and/or otherwise employed in the housing of a number of different device platforms—e.g., tablets, laptops, smart devices, mobile devices, smart phones, game controllers, remote controllers, mouse, stylus pens for smart devices, wearable devices, I/O devices and/or other devices in which a user may hold or otherwise receive a haptic response. Each of these devices may include a housing (e.g., a form factor) that has surfaces (e.g., a front side, rear side, edges or the like) with which users can interact—for example, hold, grip, balance or the like. As mentioned, individual haptic elements that are embedded and/or mated to the surfaces on and/or in the housing of such devices—and make up such multiple haptic zones—may comprise any number of haptic technologies, e.g., such as electromagnetic motors/rumblers, Eccentric Rotating Mass (ERM) vibration motors, Linear Resonant Actuator (LRA) vibration motors and/or piezo structures.

Devices are numerous in form factor and function. In one aspect, devices may be handheld—e.g. a tablet, smart phone, smart device, laptop or the like. In one aspect, devices may be large form factor devices—e.g. large screen that may have touch capability (such as a Perceptive Pixel display or the like). In one aspect, devices may be I/O devices that work in communication with any of the above devices. In one aspect, devices may be wearables—e.g., smart watches, headsets, or the like.

The haptic elements mated to or within the housing of these devices may be dynamically grouped into sets and/or zones to deliver an appropriate and/or desired haptic response to the user of the device. In operation, the devices may receive user interaction information (e.g., where is the user holding, balancing and/or gripping the device). Such information may be gathered by a set of touch sensors or signal from I/O devices (e.g., mouse, controller, stylus, tablet, laptop or the like) that the user is currently interacting with that device.

Additionally, the device may receive indications of haptic responses to be delivered to the user. Such indications may come from a variety of sources—such as operating system commands, user application commands, audio tracks, video/gaming playback, metadata or the like. The devices may determine the appropriate level of haptic response to energize (e.g. amplitude, frequency, pulse and other characteristics) and which haptic elements to be energized. The energized haptic elements may dynamically define a set of user interaction zone that may change over time, depending on the desired haptic responses to be delivered. In one aspect, the user interaction zones and/or set of energized haptic elements may be reduced and/or minimized set of energized haptic elements—thus, tending to reduce the energy consumption of the device over time.

In one aspect, the devices may have a processor residing inside of them and performing all of the aforementioned processing. In one aspect, the devices may be in remote communications with such a processor—e.g., such as an I/O device like a controller, a mouse, stylus, or wearable device, or the like and receive such haptic response signals from a computing device with which the I/O device is cooperatively working.

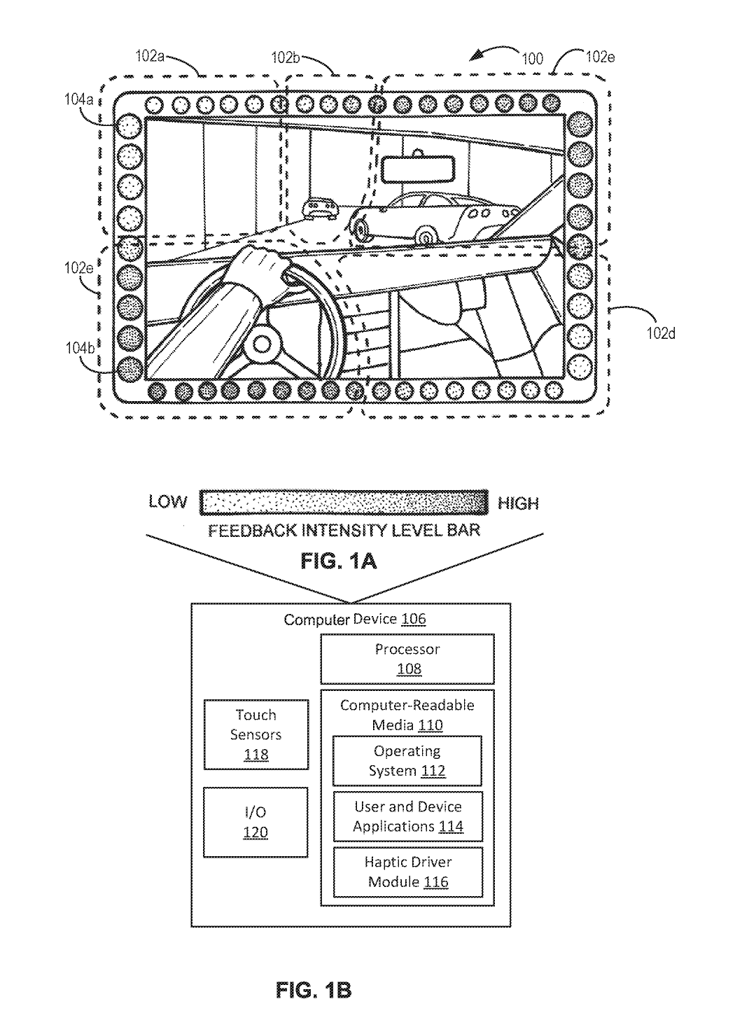

FIG. 1A depicts one exemplary embodiment of a device comprising multiple haptic zones, as made in accordance with the principles of the present application. In this example, handheld device 100 comprises a housing that mates with a screen 101 (e.g., possibly with a touch screen surface). FIG. 1B is a conceptual drawing of a computer device 106 that may be incorporated into the handheld device 100 of FIG. 1A. Computer device 106, in turn, comprises a processor 108, computer-readable storage media 110, touch sensors 118 and I/O interfaces and/or devices 120. Computer-readable storage media 110 may comprise any number of storage media (e.g., RAM, ROM, flash memory or the like) that are capable of storing computer-readable instructions that, when read by a processor, are executed by the processor to perform any desired process, function, and/or task. For example, operation system 112, user and device applications 114, and haptic driver module 116 may be some of the executable processes/instructions that stored in computer-readable storage media 110.

It should be appreciated that although FIG. 1B depicts only a single processor, device 100 may comprise a single processor or a plurality of processors, CPUs, cores and/or controllers that may work either singly or in cooperation to provide a suitable computing environment to create a desired user experience. Merely for example, processor 108 may comprise multiple processors, multi-cores, GPUs, I/O processors and the like to provide such a suitable user experience.

In addition, computing device 106 comprises optional touch sensors 118—that may be in communication with processor 108—that allow device 100 to be aware of a user's touch, presence and/or interaction with device 100. Touch sensors 120 may be embedded and/or mated anywhere in the device 100 to effectively make such detection (e.g., perhaps co-located with the haptic elements 104) and send signal data to computer device 106 regarding the user's touch, presence and/or interaction with device 100. Touch sensors 118 may also comprise touch screen sensors (e.g., to detect a user's gestures and/or touch screen commands upon a touch screen's surface).

In one aspect, touch sensors may be embedded in a handheld device to discern the user's interaction and characteristics—such as grip position, pressure and other characteristics. Orientation sensors, such as accelerators, gyroscopes, and magnetometers, may be embedded in a handheld device to discern the orientation of the device in nine degrees of movement.

Input/Output devices (I/O) 120 may comprise any number of I/O devices in order to effectively interact with the user. For example, I/O 120 may comprise a mouse, stylus pen or the like. In addition, I/O 120 may comprise any number of wired and/wireless communications or other data inputs (e.g., Ethernet, WiFi, BlueTooth, CD-ROM, memory ports or the like).

Device 100 may dynamically vary its haptic interactions with the user, depending upon what data is being input and/or rendered to the user. For example, if device 100 is executing (or otherwise running) a user application—such as email application or word processing application or the like, device 100 may interact differently with the user than if device 100 were, for example, executing and/or running a gaming application.

As may be seen in FIG. 1A, device 100 is executing a driving game application. The driving game application is causing to render a driving video (and/or audio) to simulate a particular driving scenario. The video and/or audio data may be stored as an application 114 in the computer device 106—or, alternatively, may be input into I/O 120—e.g., as streaming data from the internet, cloud server, a CD or any other input possible.

As may also be seen in this example, screen 101 is bordered by a plurality of haptic elements 104. Haptic elements 104 may be producing a desired amount of haptic feedback to the user. For example, haptic element 104a may be producing a mid-to-low amount of haptic feedback (as depicted by the Feedback Intensity Level Bar shown)—while haptic element 104b may be producing a mid-to-high amount of haptic feedback.

In addition, particular subsets of haptic elements 104 may be grouped into (or otherwise partitioned into) a plurality of haptic zones. As seen, zones 102a, 102b, 102c, 102d, and 102e may be such a desired partitioning of haptic elements 104. In this example, this multi-zone haptic actuation may allow the user to feel settled vibration from engine (vibration frequency adjusted to car speed and other parameters) on the bottom side (e.g., zone 102e) and high-amplitude vibration on the right top side of the device which may represent an enemy (e.g., zone 102c). As the game progressed, if car hits a border or an enemy on the left or right side, the user will feel feedback on the left or right side of the tablet respectively. For other haptic experiences, it may be desirable to provide the user a sense of surface deflection (e.g., for a click-like experience). This may be provided by a piezo structure, piezo disc and/or any other haptic elements that may perform such a surface deflection.

As also seen, zones 102a, 102b, and 102c may be construed as “outside” of the user's vehicle. Zone 102a may exemplify an area without cars, so the slight haptic vibrations may be commanded. Zone 102b has a car in the distant ahead and may produce a small vibration. Zone 102c has a car much closer to the user than the other car—so, higher haptic vibrations may be commanded.

For “inside” of the car, zone 102d may depict the motor vibration of user's car—while zone 102e depicts the steering wheel area and so stronger haptic vibrations may be commanded. In one aspect, the haptic response may dynamically change according to the user's input to the game's parameters. For example, if the user commands a greater speed, a stronger haptic response may be commanded in at least zone 102d. For another example, if the user commands a sharp change in steering, the haptic response may be commanded to interpret such a user' command—e.g., a jerky and/or stuttering haptic response (that might simulate the car's wheels losing traction).

In one aspect of this example, the partitions (and/or their haptic feedback) may dynamically change according to desired user experience. Haptic driver module 116 may dynamically change such partitions, zones and feedback levels in a number of different conditions. For example, the executing application may supply and/or specify particular zones and feedback levels as a part of the application data. In one aspect, zones and feedback levels may be input into device 100 via I/O 120 as metadata (or other data) to a substantially real-time streaming video stream. Such flexibility may tend to increase the user's experience in a multi-user gaming experience that may dynamically change according to other user's responses.

In one aspect, haptic driver module 116 may comprise image processing and/or machine learning modules that may interpret the input data stream and command a specified set of haptic elements into desired zones and/or their feedback levels. In one aspect, it may be desired to merely command the feedback levels of each individual haptic element—i.e., without the need to partition haptic elements into zones. It will be appreciated that the present application encompasses all of these various aspects of all of the various examples and/or embodiments described herein.

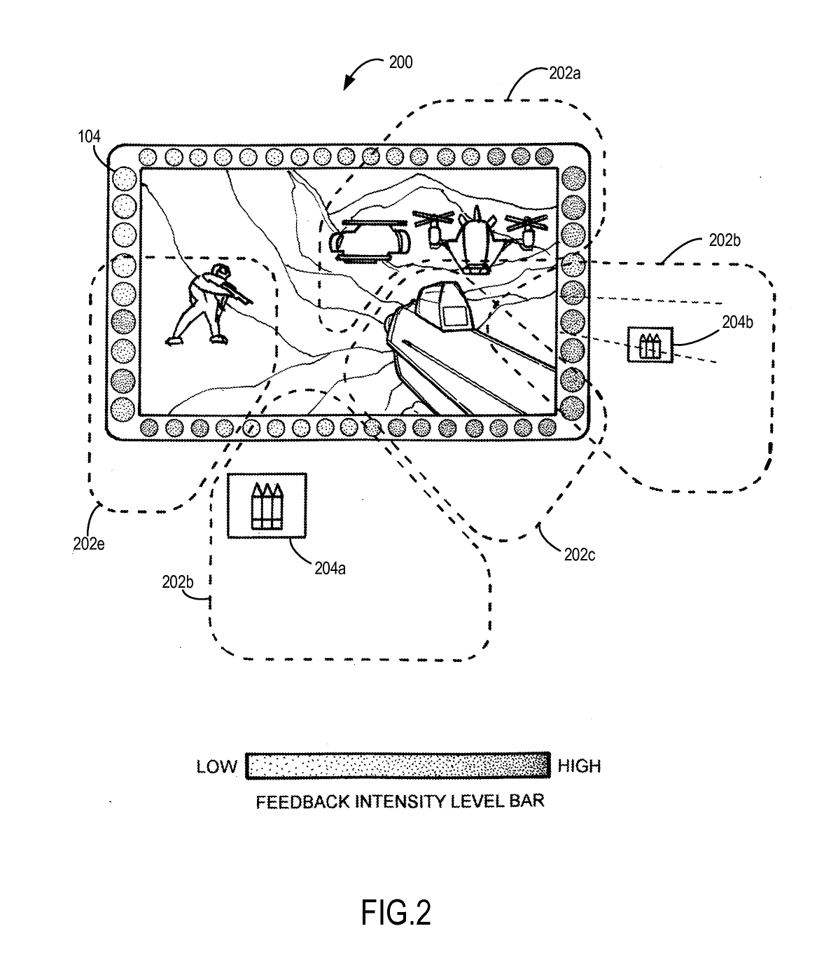

FIG. 2 depicts yet another gaming example 200 comprising a wartime game—in which the haptic elements 104 may assume different feedback intensity levels—and/or be partitioned into zones (e.g., 202a, 202b, 202c, 202d and 202e), if commanded and/or desired by haptic driver module 116. In this gaming interaction scenario (e.g., a “First Person Shooter” game), gun feedback, haptic-based radar for searching ammo (204a and/or 204b) and other game artifacts, feedback from sides for easier determining enemy position are also possible. For example, in zone 202e, the user may “feel” the presence of an enemy that is nearby with a mid-to-high haptic feedback level. Zone 202a may interpret ships in the distance with a moderate vibration. Zone 202c may be interpreted as the user's gun environment—and may deliver a haptic response appropriate as to whether the user is currently firing the gun at the time.

Zone 202b may be an “ammo” zone in the distance (as denoted by ammo icon 204b, which may be rendered on the screen in the distance)—and to give the user a discriminating sensation may give the user a wave sensation; but a low frequency (as the ammo is in the distance). By contrast, zone 202d may a wave sensation; but at a higher frequency than zone 204b (as the ammo is close to the user). In one aspect, ammo may be discerned by increased strength of haptic feedback—while enemies may be discerned by wave feedback of varying frequency. It will be appreciated that discerning haptic responses may be some combination of haptic amplitude, frequency and/or pulse rates. In another aspect, some version of audio haptic feedback may be used in combination of vibratory haptic feedback. Depending on the number of speakers and the sound environment of device 100, audio feedback may have varying spatial, volume, frequency and/or pitch parameters that may be commanded by device 100.

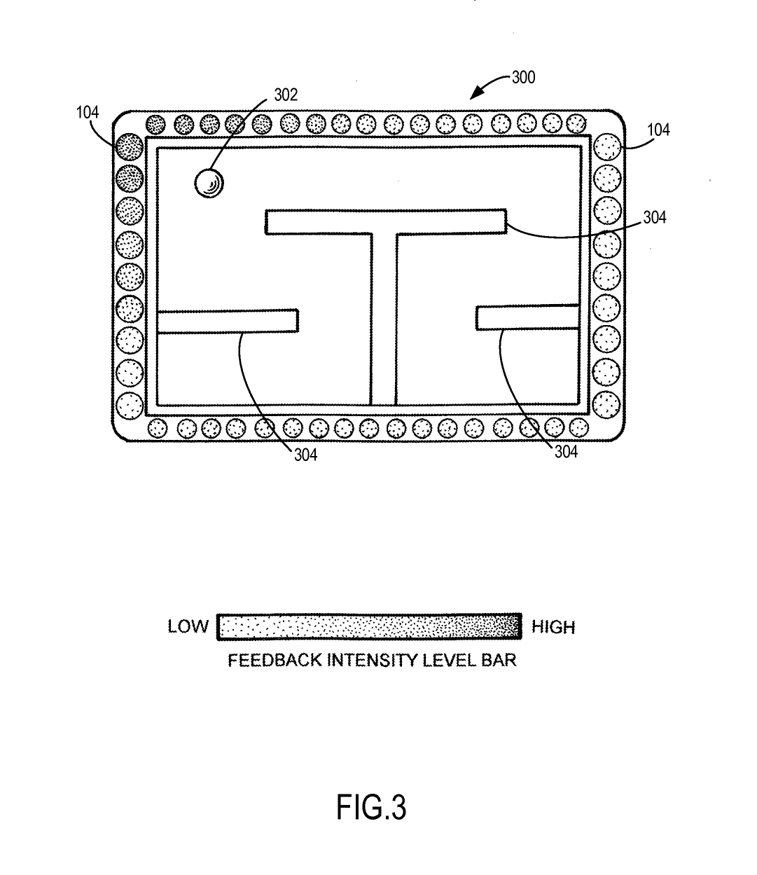

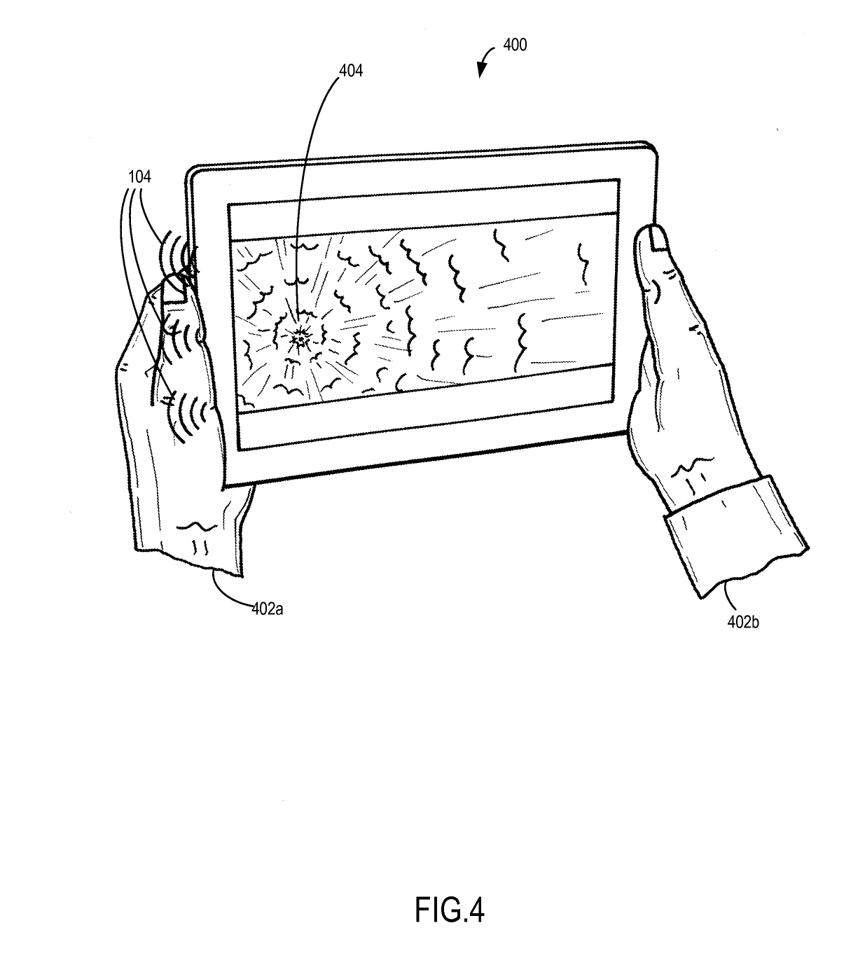

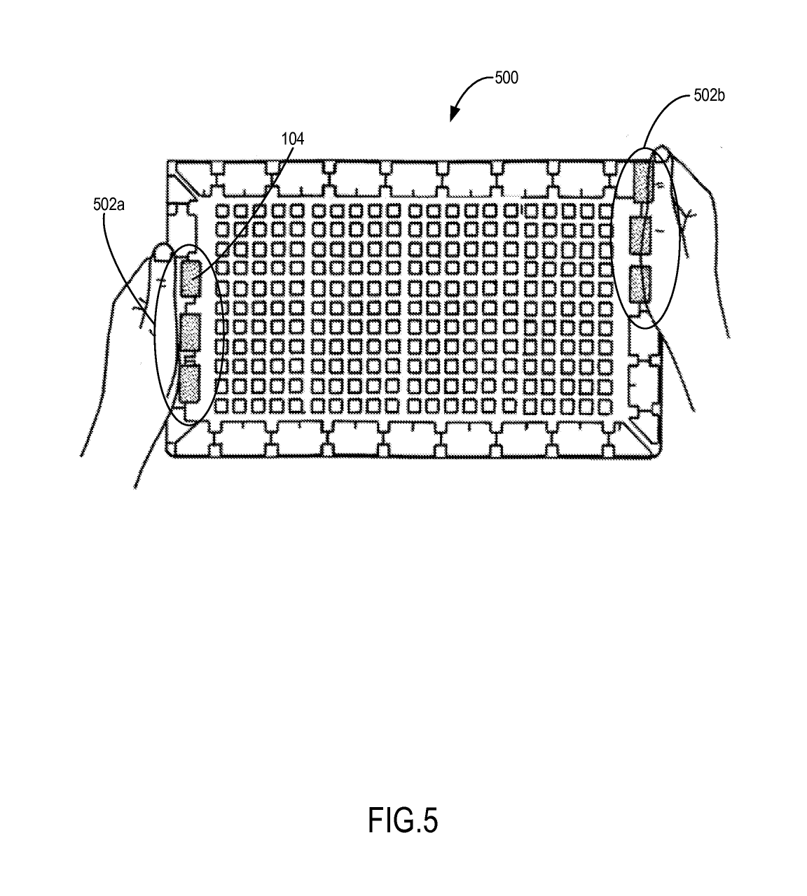

FIGS. 3 and 4 depict other gaming examples. FIG. 3 depicts a simpler marble ball game 300. Game 300 features a ball 302 that needs to be moved from one spot on the screen to another—where barriers 304 to ball movement are erected in this video game. As may be seen, game 300 is one example of realistic haptic physics simulation where strength of the feedback at haptic elements 104 correlates to the ball's position and the user's grip configuration. FIG. 4 may depict either a gaming example or a video playback example 400. In either case, example 400 shows the user's hands 402a and 402b holding the handheld device on either of its sides. On the screen, an explosion is depicted that occurs closer to user's left hand 402a than to user's right hand 402b. The handheld device may command a greater haptic (e.g. vibratory, audio or both) response closer to hand 402a than the other. The handheld device may have the haptic responses commanded as stored instructions in the game, or the haptic responses commanded as metadata that is input alongside streaming video data, or the haptic response commanded through image/scene analysis and artificially intelligent and/or machine learning algorithms—that may interpret the scene for opportunities to command haptic feedback.

FIG. 5 is a top, cut-through view 500 of the handheld device as depicted in FIG. 4. With the screen so conveniently removed from view, it may be seen that—in regions 502a and 502b (where the user's hands are hold the device)—there are a number of haptic elements 104 that cover the length of the user's hand and/or palm. In this example, it may be seen that there are three (3) haptic elements that are proximal per each of user's palm length—and that this frequency of placing haptic elements may be repeated substantially along the perimeter of the device. It may be desirable to space such haptic elements—so as to expose an average human hand to at least one haptic element that is proximal to the user's interaction (e.g., hold, grip or the like) anywhere along the surface and/or edge. In one aspect, it may be desirable to have 2-5 haptic elements proximal to the user's interaction and/or grip or hold, for a wide variety of haptic responses.

In one aspect, if the device (through sensors) has knowledge of the positions of the user's hands while interacting with the device, the device may selectively only energize those haptic elements where the user's hands happen to be. As may be seen, perhaps only 6 haptic elements may need to be energized (i.e., three haptic elements proximal to each of user's hands)—as opposed to all approximately 20-30 haptic elements around the entire periphery. This may tend to save on energy consumption of the device over time and usage.

It may be desirable to give haptic feedback to the user in response to certain commands and/or gestures that a user may give to the device while the device is executing an application.

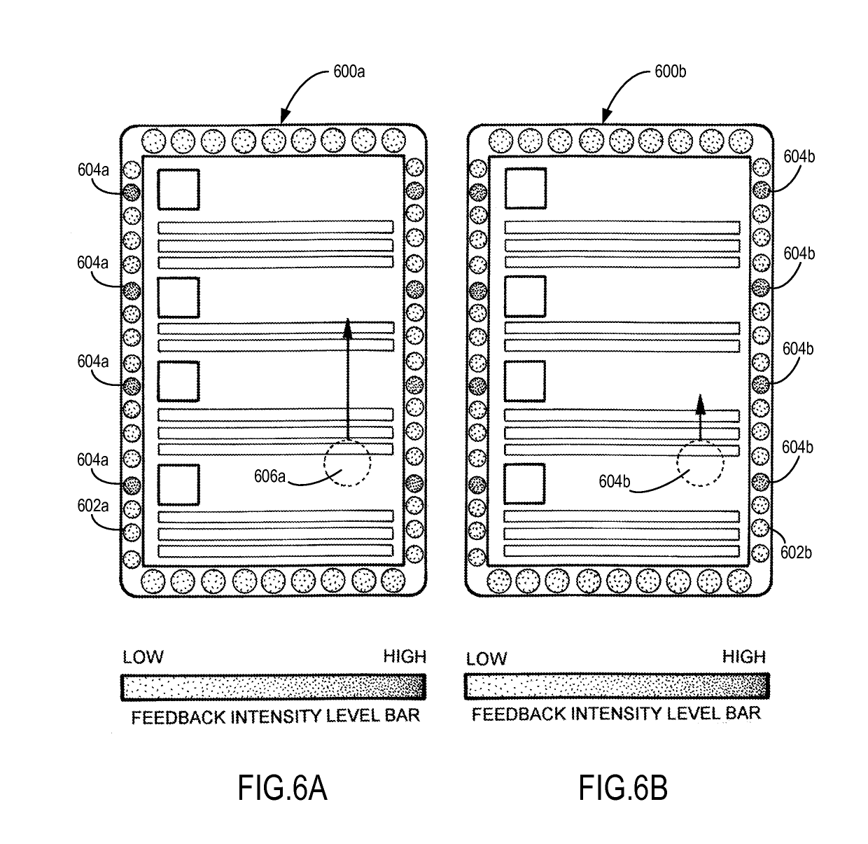

FIGS. 6A and 6B depict a haptic response given to two different user scrolling gestures—one large and one relatively small, respectively—while the device is running and/or executing an application—such as an email application, a word processing application, an office application or the like. On a device with a touch screen (600a and 600b), scrolling gestures are a typical UI input. In fact, scrolling gestures are responsive to the speed at which the user swipes the touch screen—e.g., a faster swipe associates with faster data/image scrolling on the screen.

Device 600a depicts the user commands a substantially fast swipe 606a—whereas on device 600b, the user commands a substantially slow swipe 606b.

In the case of the faster swipe 606a, haptic elements 602a and 604a may present a lower energetic haptic response overall, when compared to haptic elements 602b and 604b. The intuitive interpretation for the user may be that lower energetic haptic response correlates with a lower ambient “friction” to the scrolling—which may be expected if the user were to actually scroll a physical object in the “real world”.

In these examples, haptic elements may be divided into two or more categories for response. As may be seen in FIGS. 6A and 6B, haptic elements are depicted in two categories—602a, 602b and 604a and 604b. Haptic elements 602a and 602b may be more numerous and may provide a baseline haptic feel. Haptic elements 604a and 604b are less in number and may be substantially evenly distributed among the other haptic elements. These haptic elements may give a period “bump” (i.e., a noticeable increase in haptic response) in order to give a sense of “travel” (e.g., the distance and/or speed) of the swiping gesture.

Other characteristics may be similarly modeled by haptic elements (in either energetic response or grouped/zoning together for intuitive user interpretation) for other touch screen UI gestures. Other user applications and their runtime behavior may also be modeled by haptic elements, their characteristics, and their groupings/zonings.

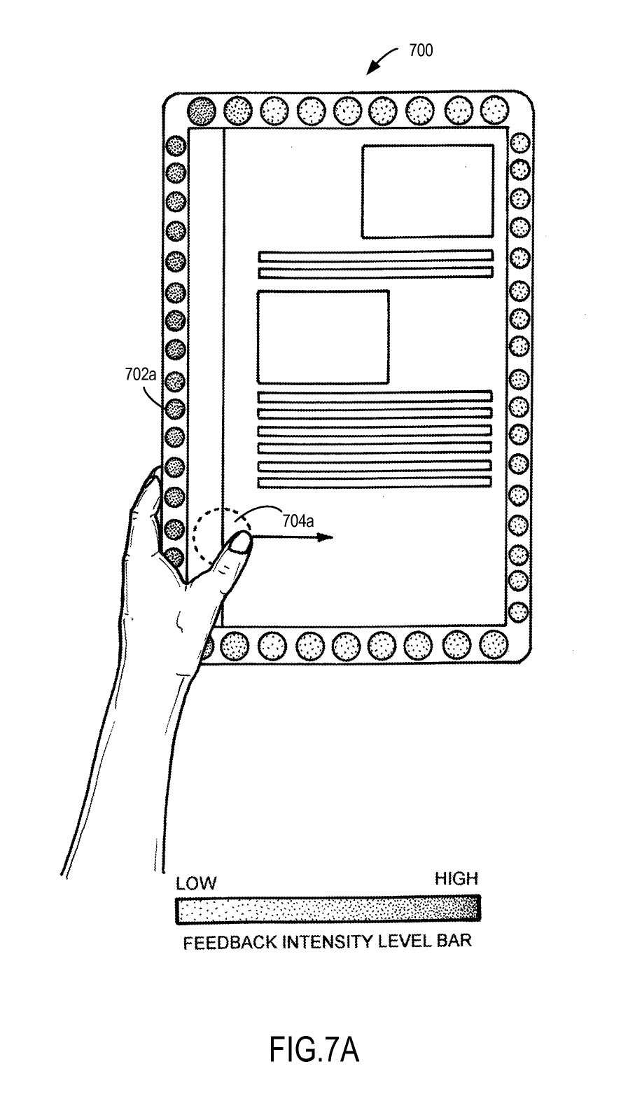

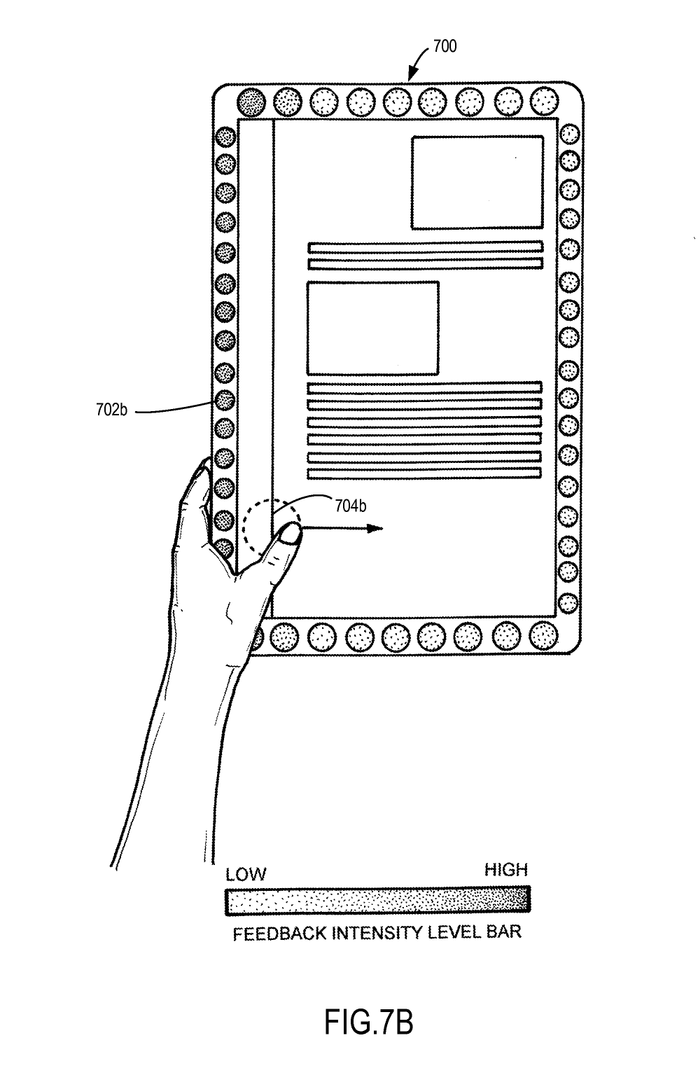

FIGS. 7A and 7B depict another example 700 of a user's touch screen gesture being appropriately modeled by haptic elements. As may be seen, the user is commanding side menu controls—e.g., as may be found in touch screen Uls for operating systems or other user applications. In FIG. 7A, the user is commanding (704a) a faster application of the side menu than in FIG. 7B with command 704b. As may also be seen, haptic element 702a that are aligned across the top and bottom border exhibit a higher energetic haptic response when compared to the same haptic elements 702b in FIG. 7B. It will be appreciated that these haptic elements in the horizontal direction may be grouped and/or zoned similar to the manner shown in FIGS. 6A and 6B.

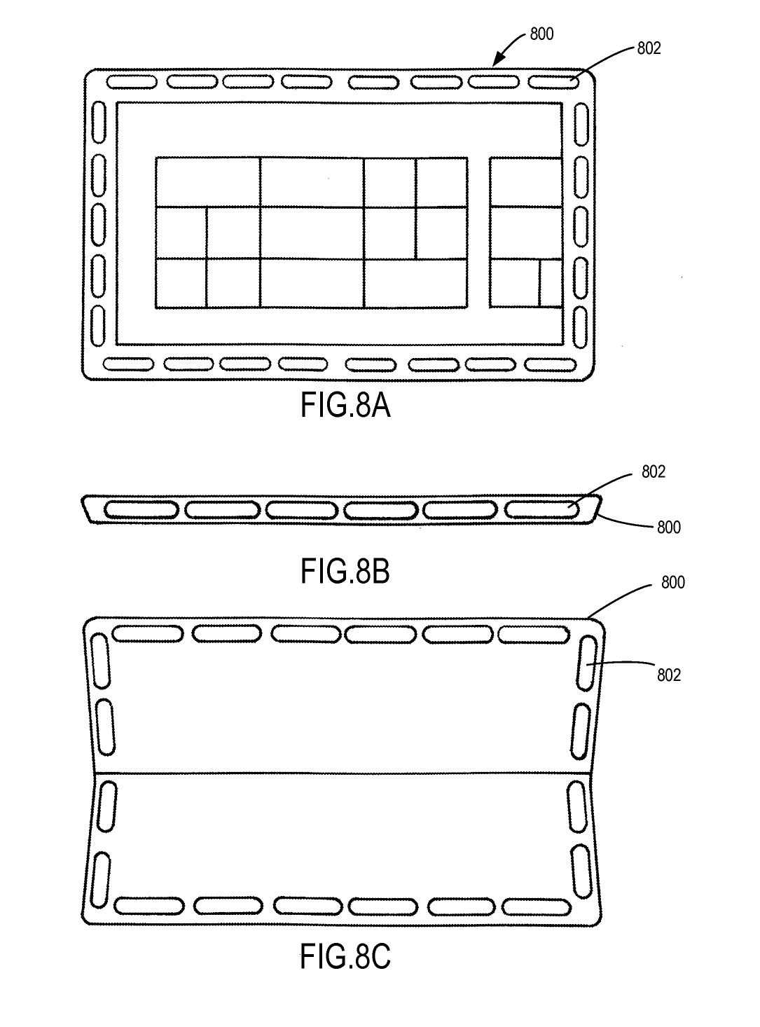

FIGS. 8A, 8B and 8C show one exemplary tablet/laptop 800 having the haptic elements 802 bordering the device. As may be seen, haptic elements 802 may be embedded and/or mated to the front side (FIG. 8A), the side (FIG. 8B) and the rear side (FIG. 8C) of the device. As mentioned above, the frequency and/or density of the placement of these haptic elements around the borders of the device may be done according to design concepts and/or heuristics—e.g., in order to effect certain modeling of user gestures and/or application behavior—or to effect certain user experiences at desired times and conditions. For merely one example, the placement of the haptic elements may be such that 2-5 haptic elements are spaced in the length of an average user's hand along a border of the device.

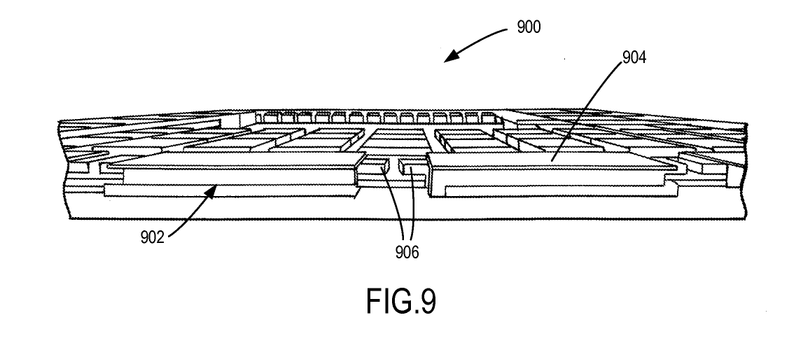

FIG. 9 is a side, cut view of a tablet/laptop 900 that shows one possible mechanical design/arrangement of haptic elements mated to the device. As mentioned, in some embodiments, it may be desirable to have sensors (e.g., capacitive, resistive, optical and the like) located in and around the haptic elements—so the device may be able to detect where the user is handling and/or gripping the handheld device. In FIG. 9, sensors 904 are placed substantially on top of haptic elements (e.g., piezo actuators) 902. Spacer elements 906 may be advantageously placed between the combined sensor/haptic elements—e g., to provide vibration isolation or the like.

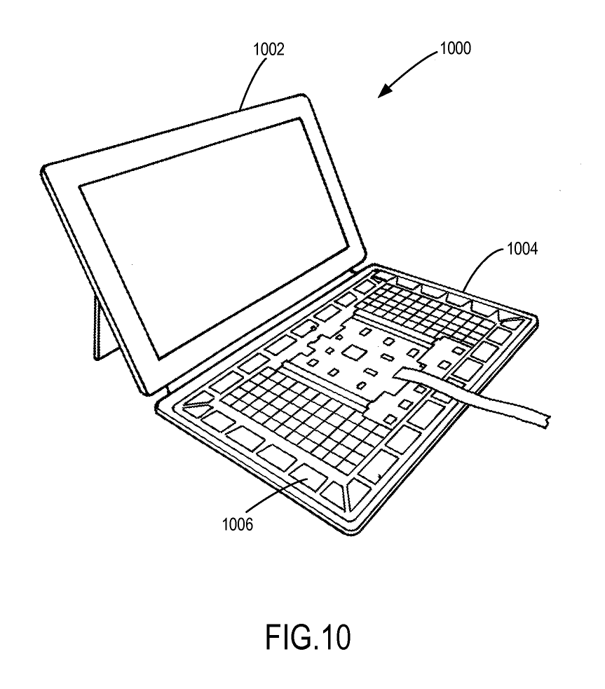

FIG. 10 depicts another example of a tablet/laptop 1000 that may employ a keyboard 1004 that may in turn be either attached (e.g., as with a laptop) or detachable (e.g., as with a tablet). Keyboard 1004 is shown in a transparent view (i.e., with front cover removed)—in order to show that haptic elements 1006 may be attached and/or mated to the keyboard, to provide a haptic experience to the user while using the keyboard.

In one example use, there may be image and/or video stream being rendered on screen 1002 that may translate to a haptic response delivered at the keyboard. In one aspect, the device may have sufficient knowledge to know whether the user is engaging with the device via the keyboard or with the screen portion of the device. This knowledge may be discerned in a number of ways—e.g., whether the keyboard is mated to the device, whether the keyboard is in a certain spatial position for user interaction (i.e., not folded back to the opposite side of the screen), and/or sensor data indicating whether and/or where the user is holding the device. If the user is holding the screen display, then the device may decide not to deliver a haptic response to the keyboard.

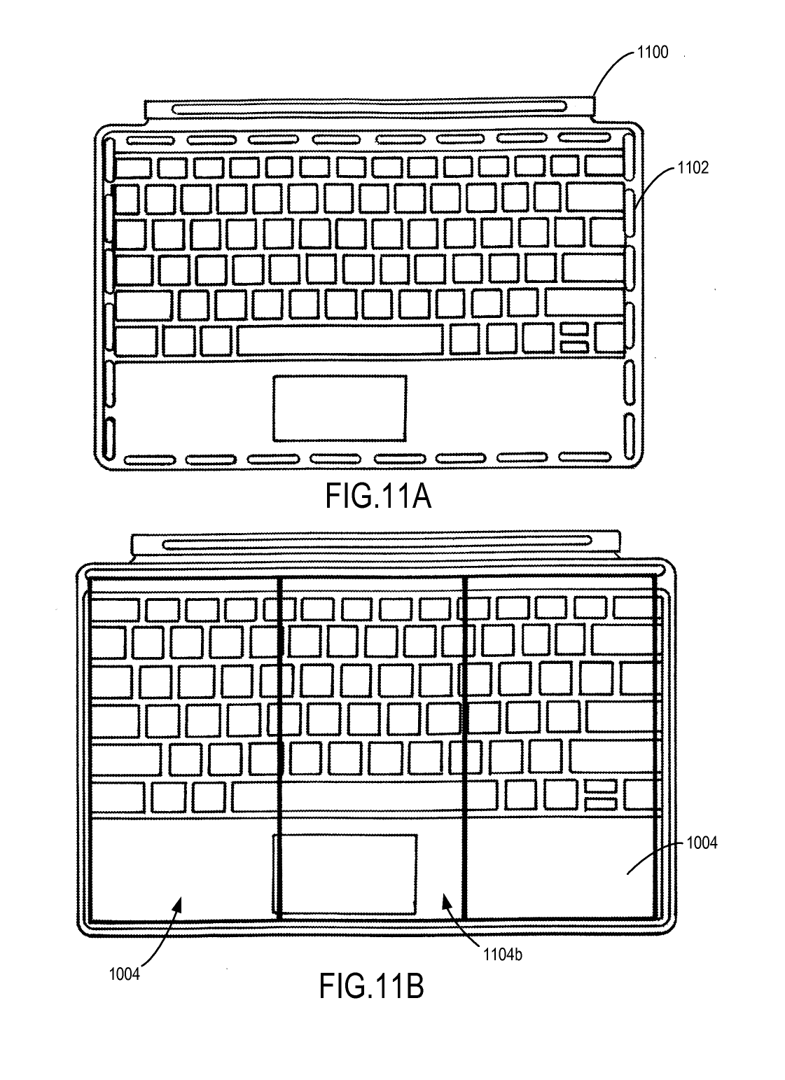

FIGS. 11A and 11B depict one manner in which a detachable keyboard 1100 may employ haptic elements 1102. In FIG. 11A, haptic elements 1102 may be placed around the border of the keyboard. In FIG. 11B, it may be seen that these haptic elements may be grouped and/or zoned into different areas of the keyboard—e.g., left side 1104a, middle 1104b and right side 1104c. These groupings and/or zonings may be affected in software settings in the haptic driver module—and/or may be affected by isolation spacers, as shown in FIG. 9.

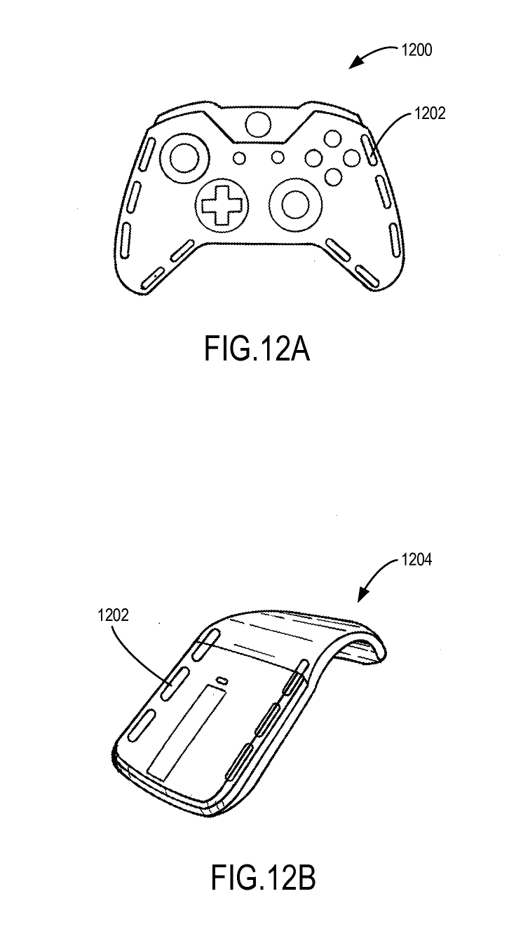

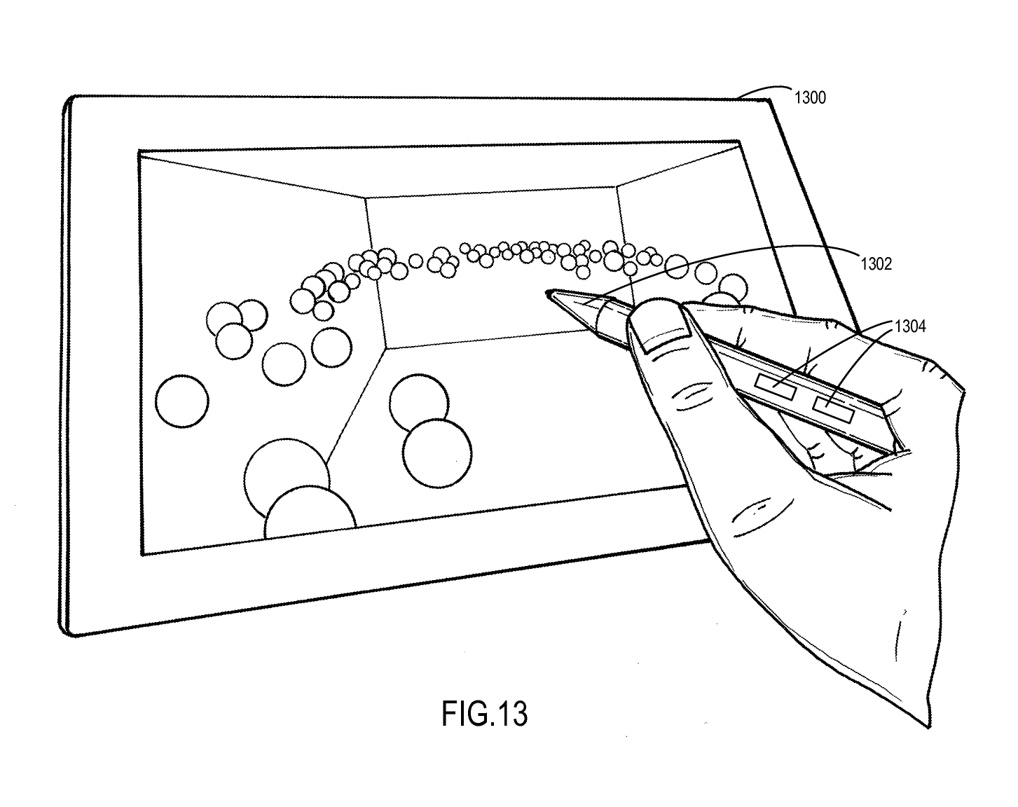

FIGS. 12A, 12B, and 13 depict the placement of haptic elements on other I/O devices (controller 1200, mouse 1204, and stylus pen 1302, respectively). In these examples, haptic elements 1202 in controller 1200 and in mouse 1204 may be spaced along the border of these devices—e.g., with a similar density to a tablet/laptop (2-5 haptic elements in the distance of a user's hand length), as these objects tend to be placed in a user's open hand.

In the case of stylus 1302, the placement of haptic elements 1304 may be less dense—as a stylus tends to be held by a few fingers and the crux between the thumb and forefinger.

Haptic responses may be delivered and associated with whatever image and/or video is being rendered to the user at the time. For example, in FIG. 13, if the user is able to “pop” one of the bubbles rendered on screen 1300, then the device may command a haptic response to the user's hand via the stylus 1303. The device may know how and in which manner the user is interacting with the device. For example, sensors (that may be co-mated with haptic elements 1202 and/or 1304) may inform the device that the user is holding the controller, the mouse and/or the stylus at any given time. The device may be able then to deliver the desired haptic response at the proper time to the specified I/O device.

In one aspect, a stylus with haptic feedback may be used as an accessibility mechanism. In this example, it may be desirable for a blind person who cannot see the information on the screen—to employ the stylus to provide feedback related to the information presented on the screen at that position. In another example, it may be desirable for a blind user who may want to understand a map or the like presented on the screen. In such a case, the blind person may get a different haptic feedback if the stylus is placed on water than if the stylus is placed on land. This mechanism may be used in combination to audible feedback as well.

In one aspect, the handheld device may be designed with the idea that a plurality of different users may be interacting with the device at the same time. Sensors in the device and in the various I/O devices that are in communication with the device itself. In such an example, it may be desired that the device deliver haptic response to all such I/O devices that may be engaged by the plurality of users. In one aspect, it may be desired to engage the haptic devices that are closer to the hand of a particular user—e.g., closer to a display or other device, as to provide a higher degree of feedback to that user.

In one aspect, it may be desirable for the device to have such knowledge of where the user(s) is (are) interacting with the device and/or its peripherals—as the device may be able to selectively engage and/or energize a suitable small and/or minimum number of haptic devices to effect the desired haptic response. Such intelligent energizing of haptic devices may lead to energy savings during the course of usage—a useful consideration for battery powered devices. In one aspect, the number of haptic elements may be reduced and optimized for desired haptic responses—a reduction in the number of haptic element may also tend to economize the energy consumption of such devices as well.

In one aspect, each of these I/O devices may have similar computing devices (e.g. like computing device 106) embedded inside. These I/O devices may have their own separate processors and computer-readable media. Other devices may have a simple processor and/or drivers on board to drive haptic elements according to command signals sent by the main device (to which it is in communication).

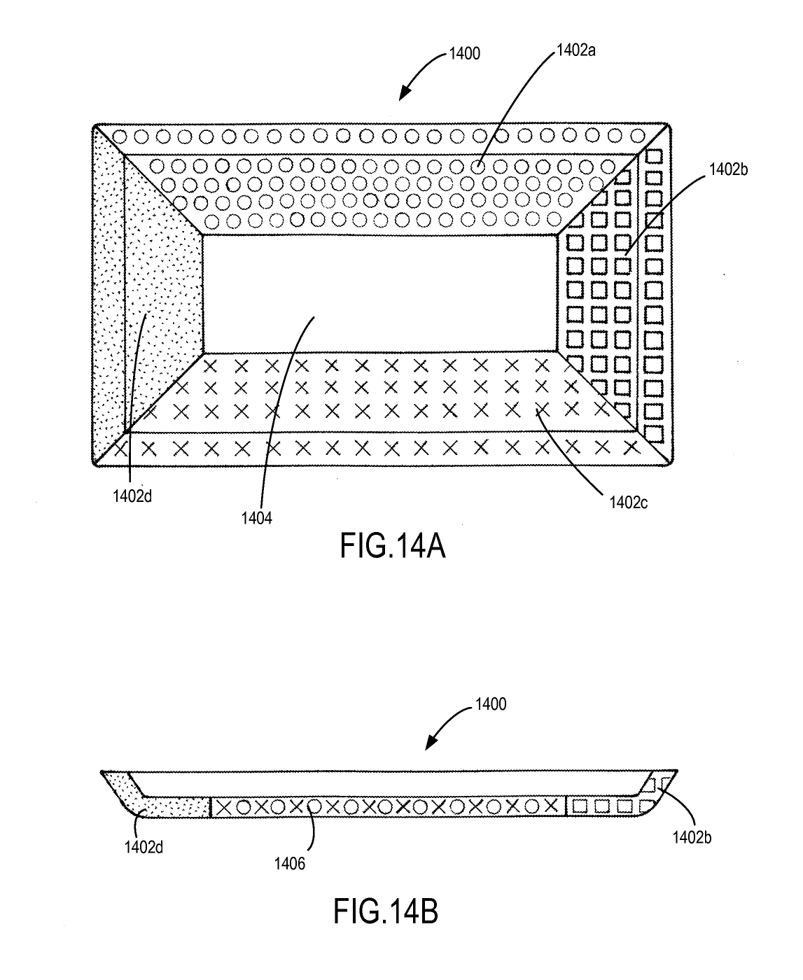

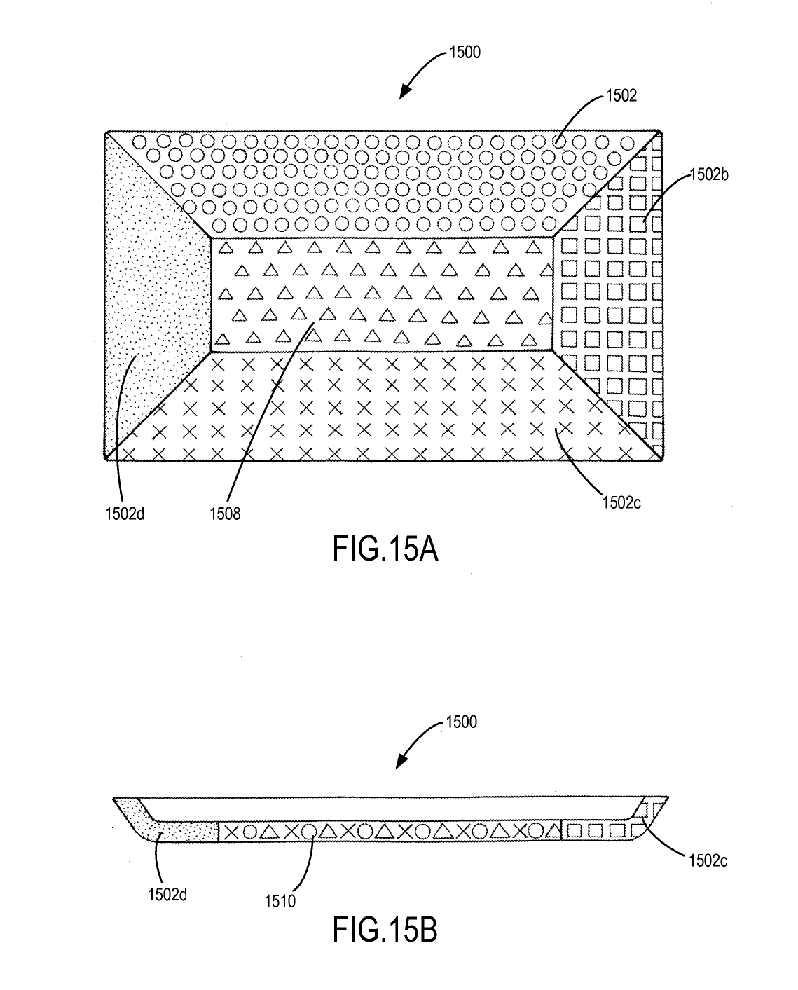

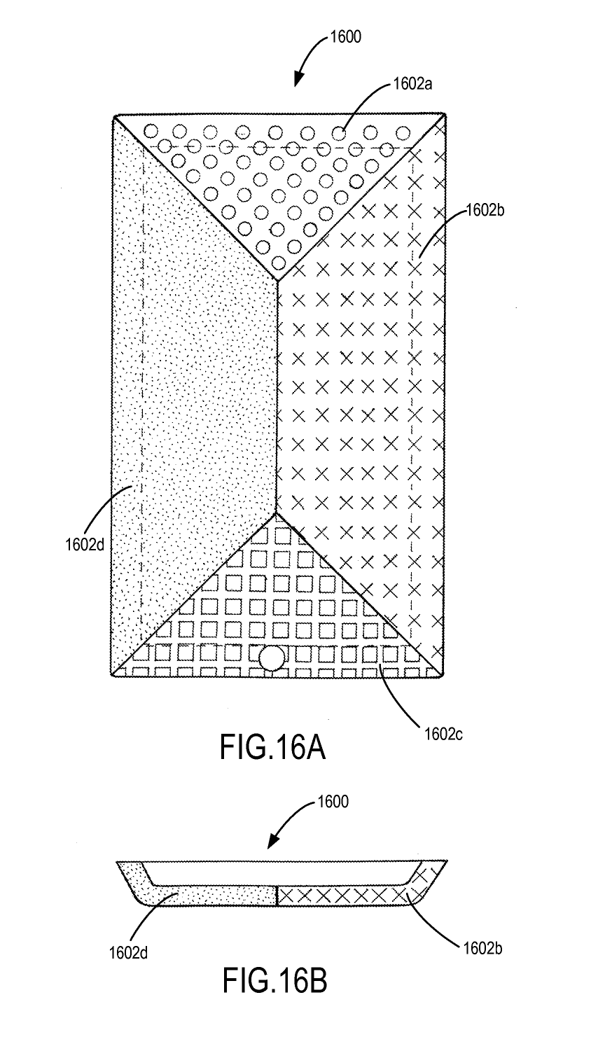

Devices may be constructed to have a number of different and/or disparate haptic zones to enhance the user's experience. As discussed, different haptic zones may be employed dynamically—e.g., where the processor may decide which individual haptic elements to energize (perhaps depending on some information about where the user is holding and/or engaging with the device). In one aspect, different haptic zones may be defined and substantially partition a surface or portion of a surface of a device. FIG. 14A shows a device in which there are four haptic zones (1402a, 1402b, 1402c and 1402d) embedded on a surface of a device 1400. In this case, the surface may not be entirely covered by haptic elements—e.g., area 1404 may be an area that is not so covered by haptic elements.

FIG. 14B shows a side, cross-sectional view of device 1400. As may be seen, the extreme left and right hand sides correspond to zones 1402d and 1402b—while the middle portion 1406 may correspond to either 1402a or 140c, depending on orientation of the device.

Each of these zones may comprise a set (e.g., array or other arrangement) of individual haptic elements—or may be one haptic element covering an area. In addition, each of these zones may be energized by the processor to give substantially the same haptic experience to the user—or there may be substantially variation of haptic experience within a zone, as desired.

FIGS. 15A and B depict the same device 1400 in which the entire surface is partitioned into different haptic zones—now including middle portion 1408. Portion 1410 may correspond to 1402a, 1402c or 1408, depending on orientation and/or user engagement.

FIGS. 16 A and B depict another device 1600 with four different haptic zones (1602a, 1602b, 1602c and 1602d) with a different area pattern. The choice of zone areas and/or patterns may differ for different devices and different purposes.

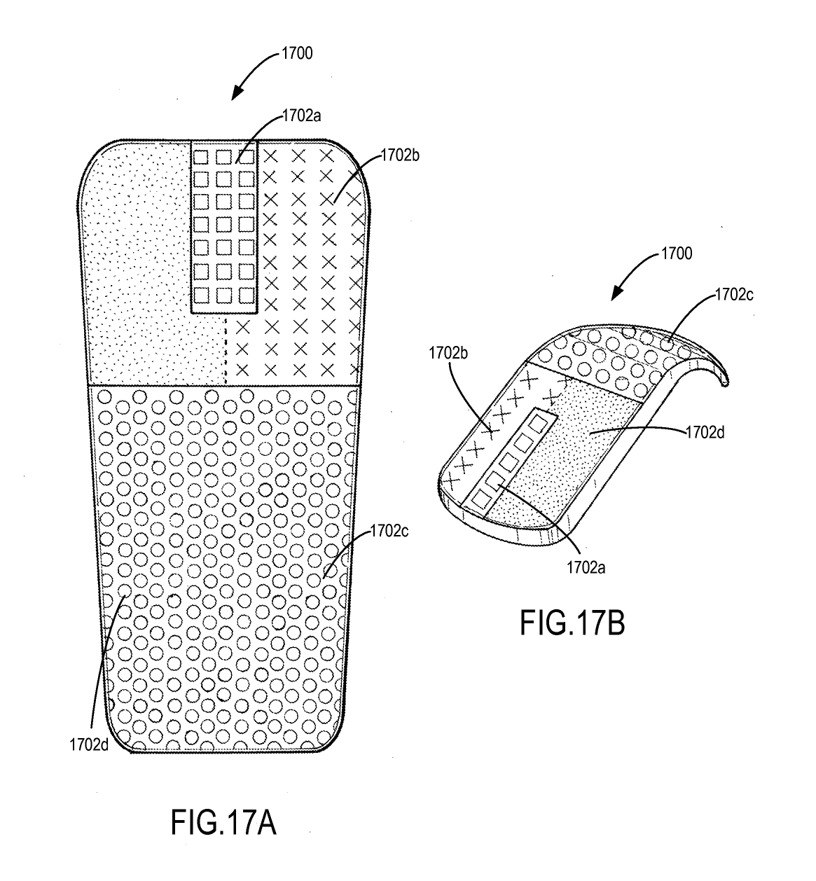

FIGS. 17A and B show a front view and a perspective view, respectively, of a mouse 1700 that has four different haptic zones (1702a, 1702b, 1702c and 1702d) that substantially partition the surface of the mouse.

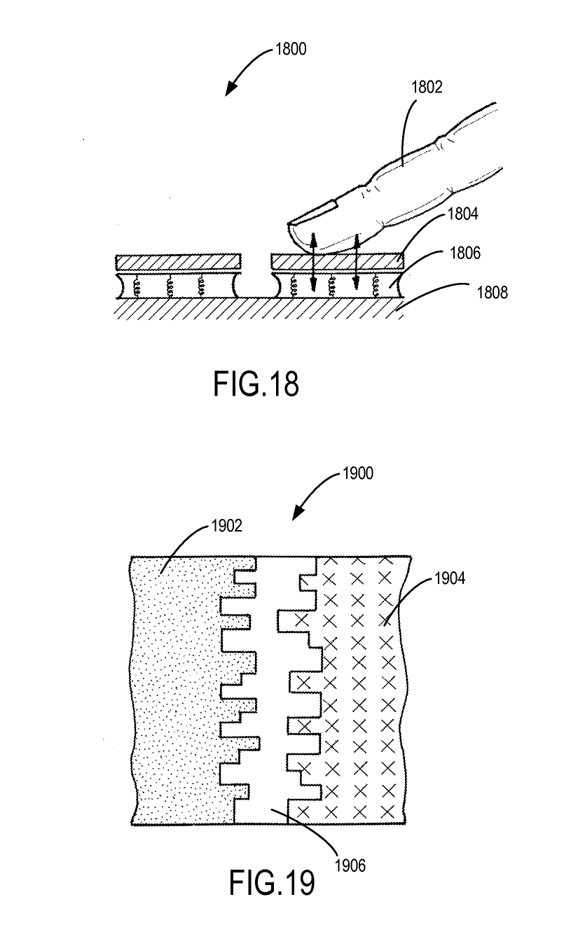

In one aspect, it may be desirable to provide some haptic isolation between either haptic elements and/or haptic zones. FIG. 18 is a side cross-sectional view of a device 1800 in which either haptic elements and/or zones (1804) may be substantially isolated from each other in a vertical fashion. As shown, haptic element 1804 may be mated to the surface 1808 of the device by a middle layer 1806. Middle layer 1806 may comprise any number of haptic and/or movement damping material. For example, layer 1806 may comprise a double sided tape that has a spring-like property (as schematically depicted by springs in the figure). It may also comprise a rubber-like material, a malleable polymer and/or foam (or other material with air pockets/holes) to provide motion/vibration/haptic damping and/or isolation. As may be seen, user's finger 1802 would be substantially isolated from other zones as a result of this layer.

FIG. 19 is a partial front view of a device 1900 where two different haptic zones 1902 and 1904 are provided substantially haptic isolation by a layer 1906 that is placed horizontally between these zones on the device. Layer 1906 may comprise any of the same materials as mentioned for layer 1806 above. As may be seen, layer 1906 may be either irregularly shape or regular shape, as desired.

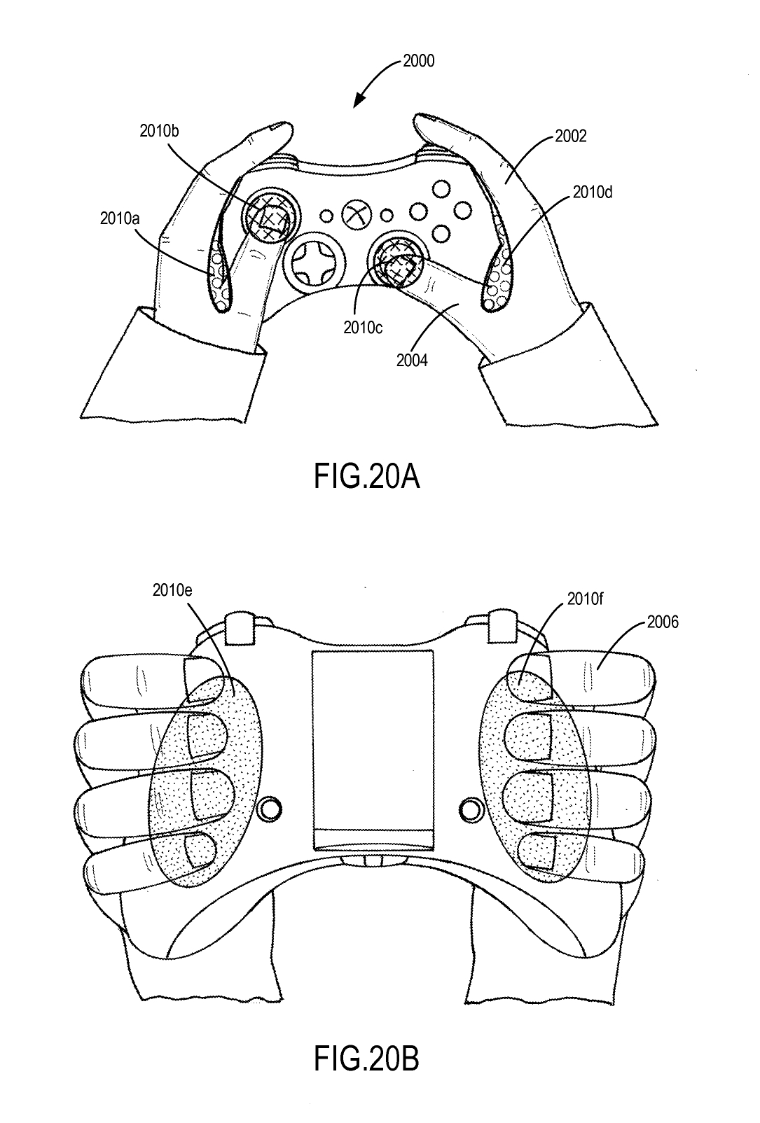

FIGS. 20A and B show front view and a rear view of a game controller 2000 respectively. On the front surface, there may be haptic zones (2010a, 2010b, 2010c and 2010d) that may deliver different haptic experiences to the user hand or portions thereof (2002, 2004 and 2006). The rear surface may comprise two haptic zones (2010e and 2010f) or more zones, as desired.

Different haptic zones may comprise different haptic elements for a desired haptic experience for the user. For one example, the haptic zones on the front side of game controller 2000 may be one of a haptic element that gives vibrations (e.g., rumblers) or clicks or the like, as desired. Zones 2010e and 2010f may comprise electro-active polymers for a more tactile experience—while other zones may give the impression of explosions and the like and may comprises rumblers and/or click-like haptic elements.

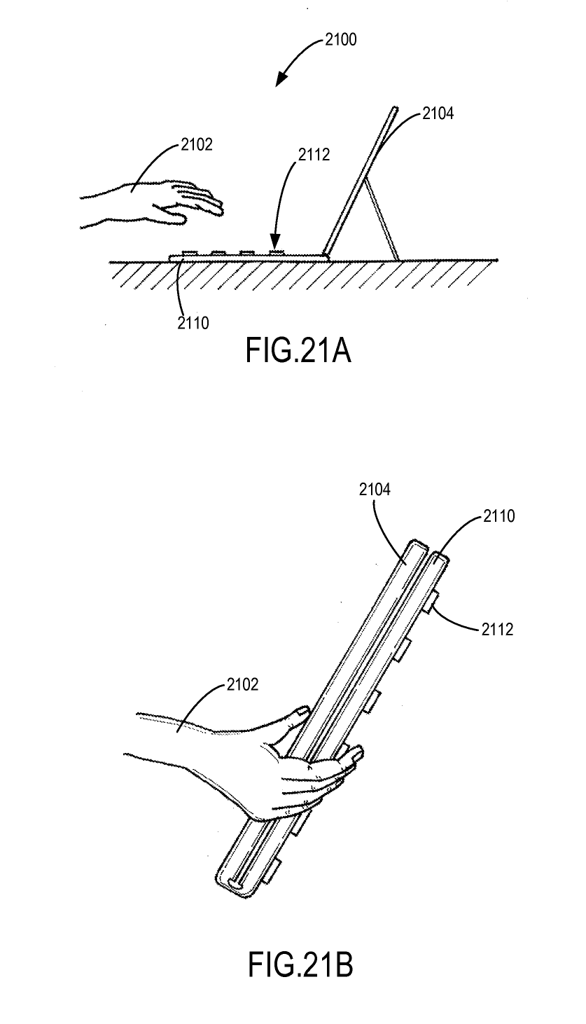

FIGS. 21A depicts a side view 2100 of a smart device/tablet/laptop 2104 in which keyboard 2110 is attached (either detachable or non-detachable) and deployed so that user 2102 may type upon the keyboard. Keyboard 2110 comprises keys 2112 and may have haptic elements underneath the keys—and/or may have haptic elements embedded in the keyboard in other places. It may or may not be the case that smart device 2014 has separate haptic elements—the user may receive haptic experiences solely from the keyboard in some cases.

FIG. 21B depicts smart device 2104 where keyboard 2110 may be folded back on device 2104. In this case, the user 2102 may receive haptic elements from the keyboard. The device may interpret the keyboard when folded back on the device to be acting more as a surface of the device for haptic engagement with the user, rather than as a keyboard for typing. The device may have different states for user interaction with the keyboard, depending on sensor data, switch settings or the like to inform the device as to the orientation of the keyboard.

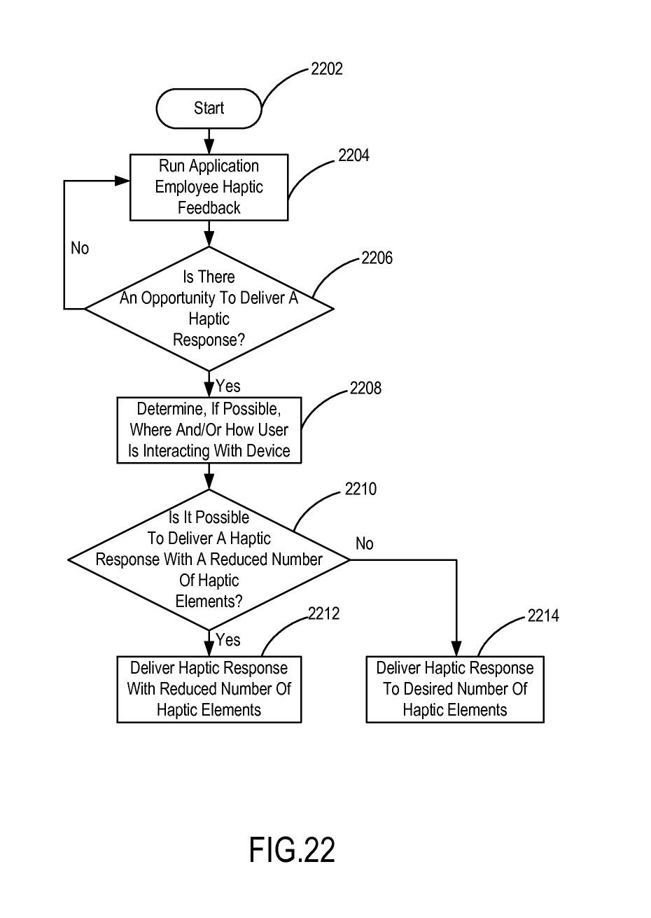

The devices that may have haptic elements may include processes and algorithms associated with haptic element use. FIG. 22 is one flowchart embodiment for a device that has haptic elements attached and/or mated to the device. This process may start at 2202 and start, run and/or execute an application for which haptic feedback to user(s) may be possible and/or desired at 2204. Such an application may be the operating system, a user application, a video playback, a game application and/or any other application or process possible.

While this application is running/executing, the device may detect opportunities to deliver a haptic response to the user(s) at 2206. The opportunity to deliver a haptic response may be determined in a variety of ways as discussed herein. For example, an opportunity may arise according to a user's gesture (e.g., on a touch screen panel) or other I/O input. Another opportunity may arise according to metadata that is associated with the execution of the application (e.g., metadata that may accompany a video data stream). Another opportunity may arise according to image processing algorithms, scene analysis algorithms, machine learning algorithms and/or artificial intelligence algorithms that may—e.g., analyze an image or a set of images in video stream and determine that a haptic response should be delivered in response to the image being rendered upon a screen. Other opportunities to deliver a haptic response may be determined by the device in other ways and/or manners.

At 2208, the device may optionally determine where user(s) are physically interacting and/or engaging with the device. This determination may be made in a number of ways. For one example, there may be sensors attached and/or mated to the device and/or its peripheral devices to detect the presence of the user's hand, grip or other physical manifestation. For another example, the device may be able to detect whether I/O signals are being sent from a keyboard, mouse, controller and/or stylus. Such signals correlate well with the user's presence. Other manners of determining a user's presence are possible for the purposes of the present application.

In another embodiment involving a gaming and/or video entertainment environment, a number of users may be sitting around a video screen while a game and/or video is playing. For any users/viewers holding controllers or other I/O devices, there may be an opportunity to determine the various locations of these users and/or devices—and an appropriate haptic response may be individually delivered to these various devices according the location and/or position of the users/devices within the viewing area.

At 2210, the device may determine whether it is possible to affect a haptic response to user(s) with a reduced number of haptic elements. In one example, if the device has a number of sensors that may determine where the user(s) is/are engaging with the device(s), then a smaller number of haptic elements may be energized. In this manner, the device may be using a smaller amount of energy over time.

If it is possible for the device to deliver a haptic response to a reduced/smaller number of haptic elements, the device may do so at 2212. Otherwise, the device may deliver a haptic response to all desired haptic elements (i.e., possibly without the knowledge of substantially where the user is holding/engaging the device) at 2214.

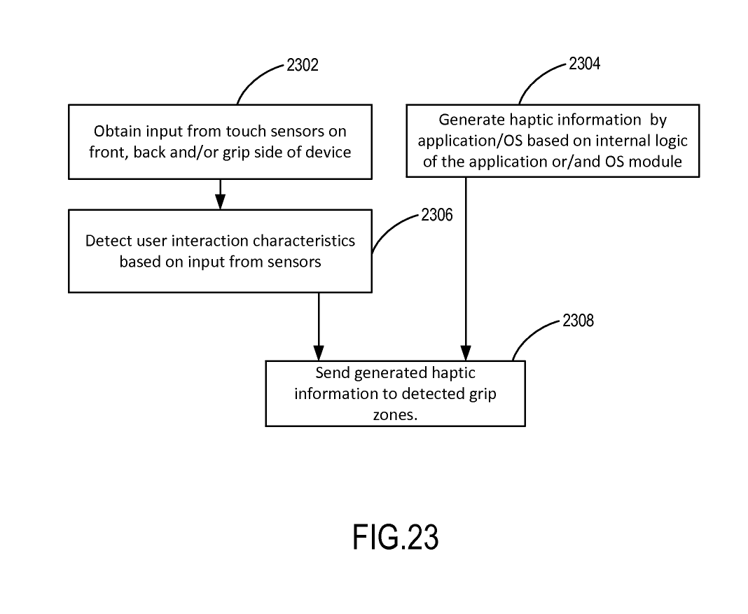

FIG. 23 is a flowchart embodiment of a process for delivering a haptic response to a reduced number of haptic elements based on the user's interaction (e.g., hold, grip, etc.) and characteristics (e.g., position, pressure, etc.) with the device. At 2302, the device may obtain input from touch sensors wherever they may be embedded or arrayed in the device (e.g., front, side, back, grip side of the device or the like). At 2306, the device may discern or detect the user interaction/characteristics with the device and/or its peripherals based on such sensor data—or from I/0 data sent from peripheral devices in communication with the device.

At 2304, the device may be generating an appropriate haptic response/information depending on the application/operating system/video data, etc. being rendered and/or displayed to the user. Such haptic information and/or response may also be generated according to a set of rules, logic and/or heuristics of an application or the operating system.

At 2308, the device may send the generated haptic information/response to the detected zone of user interaction. As mentioned, such a targeted haptic response may tend to save on energy consumption during the course of device operation. In one aspect, it may be possible to adjust the haptic response based on the user interaction data. For example, if user grip data is obtained, then certain rules and/or heuristics may be applied—e.g., for one example, if user is employing high pressure in a grip, then it may be possible to reduce the energetic response of the haptic response.

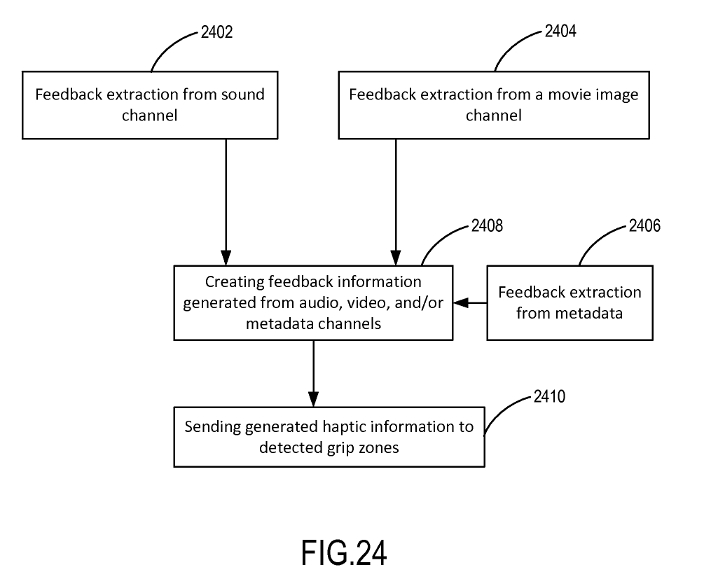

FIG. 24 is one flowchart embodiment for a process of generating and/or creating and sending haptic information/response when a game/video data stream is presented to a user(s). At 2402, 2404, 2406, various haptic feedback may be extracted from a variety of sources. For example, at 2402, the audio channel of a game/video stream may contain information for the opportunity for haptic feedback. Such information may be extracted from a game/video stream by sampling both the amplitude and/or frequency of the sound associated playback. If a loud, explosive noise occurs in the soundtrack, this may be detected and the haptic feedback information may be extracted.

At 2404, haptic feedback extraction may be made from the video/image data during playback. Image and/or scene analysis may detect moving objects within a scene and may also determine when, e.g., collisions occur in a scene. Haptic feedback information may be extracted by machine learning and/or artificially intelligent processes that analyze such scenes.

At 2406, haptic feedback information may be embedded by the producers of the game/video stream and the metadata may be streamed together with the game/video data. In such a case, the metadata may be extracted and used to generate haptic information/response therefrom.

At 2408, the various sources of feedback extraction (e.g., from audio channel, video channel, metadata or the like) may be utilized to create an appropriate feedback response/information. At 2410, the device may send the haptic information/response to any desired set of haptic elements and/or zones. This may also be send to any detected user interaction/grip zones that may have been detected according to any such process described herein (e.g., either through touch sensors or peripheral I/O data or the like).

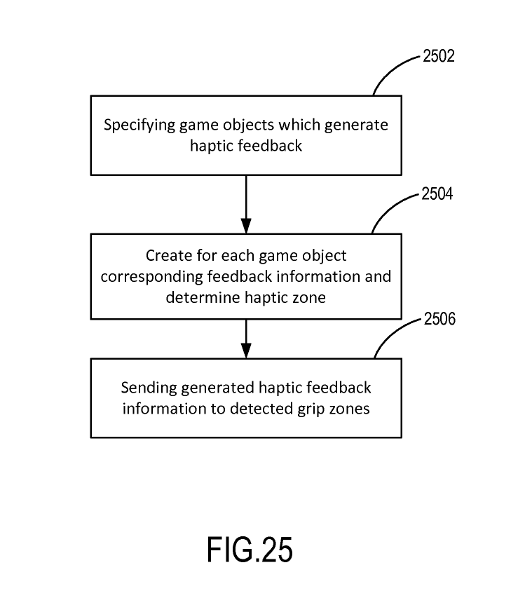

FIG. 25 is a flowchart embodiment of a process for providing haptic response/information during a game playback—which may have game objects moving in the video scenes (e.g., similar to the marble game as noted above). At 2502, the device may specify game objects in the video stream that may be involved in generating a haptic feedback. This specification may be discerned in a number of different ways. For example, scene analysis may determine objects that are moving and objects that are stationary in a scene. In addition, metadata may be embedded in the video stream by the producers and/or content creators.

At 2504, as these game objects interact within a scene, the device may create for each game object a corresponding haptic responses/information and may also determine the given haptic elements and/or zones to be energized for such interactions, as described herein. At 2506, the device may send the haptic response/information to any desired set of haptic elements and/or zones, as also described.

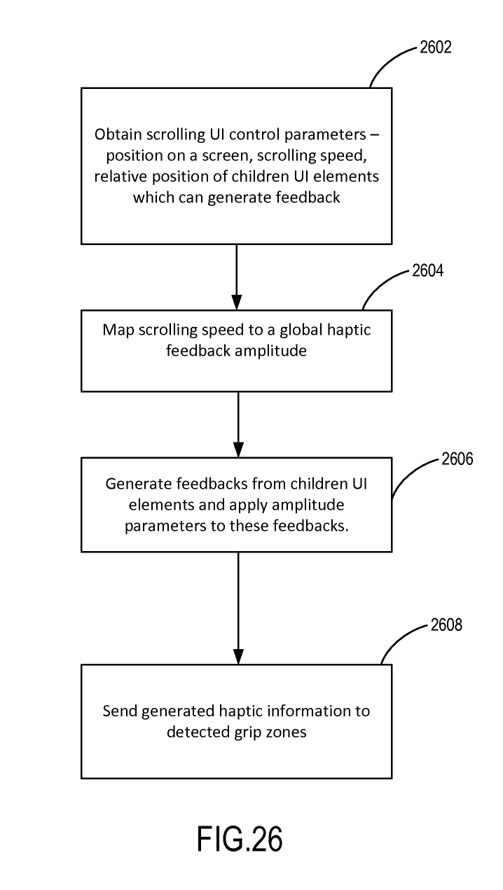

FIG. 26 is a flowchart embodiment of a process for generating haptic responses for scrolling commands upon a touch enabled device. At 2602, the device may obtain user scrolling commands and/or scrolling UI control parameters—e.g., position on the screen of scroll command initiation, scrolling speed, scrolling direction, as well as the relative position of other UI (e.g., children) elements for which a haptic response may be generated. Such other (children) elements may comprise: categories names in a ListBox control, news titles on a news webpage, VIP persons in a contact list or the like.

At 2604, the device may map scrolling speed (and/or other characteristics and parameters) to a global haptic response/feedback amplitude and/or frequency. This amplitude may be generated according to a set of rules and/or heuristics—e.g., faster scrolling maps to a desired amplitude, faster scrolling maps to a lower frequency or the like).

At 2606, the device may generate any haptic feedback from the other, children UI elements and apply these haptic feedbacks to the base haptic response according to the scrolling. At 2608, the device may send the generated haptic response/information to the desired haptic elements and/or detected user interaction/grip zones, as desired.

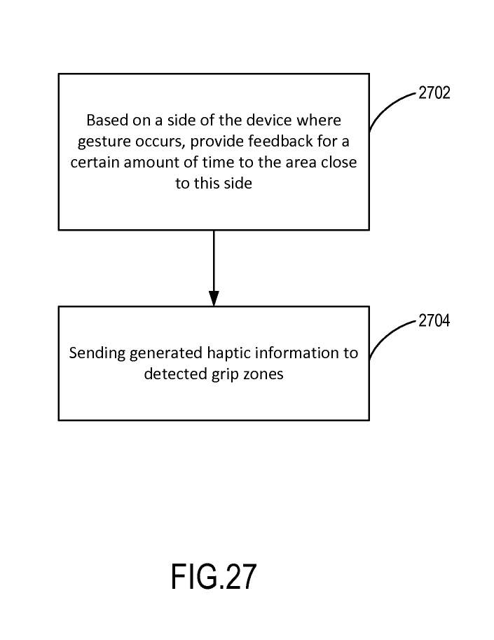

FIG. 27 is a flowchart embodiment of a process for generating haptic responses for the side gestures, as described herein. At 2702, the device may notice which side of the device where the user gesture has occurred—and generate/provide the haptic feedback for a certain amount of time for the area on the near to the gesture. At 2704, the device may send the generated haptic response/information to the desired haptic elements and/or detected user interaction/grip zones, as desired.

The following are merely examples given herein.

### Example 1

An electronic device including: a housing, the housing including a surface, the housing configured to be held by a user; two or more haptic elements mated to the housing along the surface, the haptic elements spaced along the surface to allow a set of user interaction zones to be defined; the haptic elements being in communication with a processor, the processor configured to: receive user interaction information; receive indications to deliver a haptic response; determine a haptic response based upon the indications; and determine a number of haptic elements to energize to provide the haptic response based upon the user interaction information and the desired number of haptic elements defining a set of user interaction zones to deliver the haptic response.

### Example 2

The electronic device of Example 1 wherein the electronic device includes one of a group, the group including: a laptop, a tablet, a smart phone, a mobile phone, a mouse, a controller, a touch enabled screen, a smart wearable, a keyboard and a stylus.

### Example 3

The electronic device of any preceding Examples 1 through 2 wherein the haptic elements being spaced along the surface sufficiently such that the user's interaction is proximal to at least one haptic element.

### Example 4

The electronic device of any preceding Examples 1 through 3 wherein the processor is embedded with the electronic device.

### Example 5

The electronic device of any preceding Examples 1 through 4 wherein the electronic device is in remote communication with the processor.

### Example 6

The electronic device of any preceding Examples 1 through 5 wherein the user interaction information includes one of a group, the group including: user's grip location, user's grip pressure and which I/O device the user is currently using.

### Example 7

The electronic device of any preceding Examples 1 through 6 further including: a set of touch sensors embedded along the housing and the touch sensors capable of detecting user interaction information.

### Example 8

The electronic device of any preceding Examples 1 through 7 wherein the indications to deliver a haptic response include one of a group, the group including: operating system commands, user application commands, audio tracks, video/game playback and metadata.

### Example 9

The electronic device of any preceding Examples 1 through 8 wherein the desired haptic response is associated with the currently executing application with which the electronic device is interacting.

### Example 10

The electronic device of any preceding Examples 1 through 9 wherein the desired number of haptic elements to energize as a set of user interaction zones is capable of delivering the desired haptic response with a substantially minimal number of haptic elements.

### Example 11

The electronic device of any preceding Examples 1 through 10 wherein the set of user interaction zones is dynamically created according to the currently executing application and current user interaction information.

### Example 12

A method including: executing an application capable of employing haptic feedback; determining a desired haptic response upon receipt of an indication to deliver a haptic response; determining user interaction information; and dynamically determining a set of haptic elements to energize with desired haptic response signals, based on the user interaction information, the set of energized haptic elements defining a set of user interaction zones.

### Example 13

The method of any preceding Examples 12 through 12 wherein the method further including: sending the desired haptic response signals to the electronic device remotely from a processor determining the desired haptic response signals.

### Example 14

The method of any preceding Examples 12 through 13 wherein determining a desired haptic response upon receipt of an indication to deliver a haptic response further includes receiving the indication from one of a group, the group including: operating system commands, user application commands, audio tracks, video/game playback and metadata.

### Example 15

The method of any preceding Examples 12 through 14 wherein determining a desired haptic response upon receipt of an indication to deliver a haptic response further includes automatically performing scene analysis in a video/game playback to determine whether a haptic response is desired.

### Example 16

The method of any preceding Examples 12 through 15 wherein determining user interaction information further includes determining a grip zone from one of a group, the group including: a set of touch sensors embedded in the electronic device and signals from an I/O device with which the user is interacting.

### Example 17

The method of any preceding Examples 12 through 16 wherein dynamically determining a set of haptic elements to energize with desired haptic response signals further includes determining a substantially minimal set of haptic elements that are proximal to user's grip zone.

### Example 18

A haptic system including: two or more haptic elements; a processor in communication with the haptic elements, the processor configured to: receive user interaction information; receive indications to deliver a haptic response; determine a haptic response based upon the indications; and determine a number of haptic elements to energize to provide the haptic response based upon the user interaction information and the desired number of haptic elements defining a set of user interaction zones to deliver the haptic response.

### Example 19

The haptic system of any preceding Examples 18 through 18 wherein the haptic elements are individual addressable and are configured to provide multiple amplitudes of haptic feedback.

### Example 20

The electronic device of any preceding Examples 18 through 19 wherein the set of user interaction zones are dynamically partitioned.

### Example 21

A device including: means for executing an application capable of employing haptic feedback; means for determining a desired haptic response upon receipt of an indication to deliver a haptic response; means for determining user interaction information; and means for dynamically determining a set of haptic elements to energize with desired haptic response signals, based on the user interaction information, the set of energized haptic elements defining a set of user interaction zones.

### Example 22

A device of any preceding Example 21 through 21 further including: means for sending the desired haptic response signals to the electronic device remotely from a processor determining the desired haptic response signals.

### Example 23

The device of any preceding Examples 21 through 22 wherein determining a desired haptic response upon receipt of an indication to deliver a haptic response further includes receiving the indication from one of a group, the group including: operating system commands, user application commands, audio tracks, video/game playback and metadata.

### Example 24

The device of any preceding Examples 21 through 23 wherein means for determining a desired haptic response upon receipt of an indication to deliver a haptic response further includes means for automatically performing scene analysis in a video/game playback to determine whether a haptic response is desired.

### Example 25

The device of any preceding Examples 21 through 24 wherein means for determining user interaction information further includes means for determining a grip zone from one of a group, the group including: a set of touch sensors embedded in the electronic device and signals from an I/O device with which the user is interacting.

### Example 26

The device of any preceding Examples 21 through 25 wherein means for dynamically determining a set of haptic elements to energize with desired haptic response signals further includes determining a substantially minimal set of haptic elements that are proximal to user's grip zone.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. An electronic device comprising:
a housing, the housing comprising a surface, the housing configured to be held by a user;
two or more haptic elements mated to the housing along the surface, the haptic elements spaced along the surface to allow a set of user interaction zones to be defined;
the haptic elements being in communication with a processor, the processor configured to:
receive user interaction information;
receive indications to deliver a haptic response;
determine a haptic response based upon the indications; and
determine a number of haptic elements to energize to provide the haptic response based upon the user interaction information and the desired number of haptic elements defining a set of user interaction zones to deliver the haptic response.

2. The electronic device of claim 1 wherein the electronic device comprises one of a group, the group comprising: a laptop, a tablet, a smart phone, a mobile phone, a mouse, a controller, a touch enabled screen, a smart wearable, a keyboard and a stylus.

3. The electronic device of claim 1 wherein the haptic elements being spaced along the surface sufficiently such that the user's interaction is proximal to at least one haptic element.

4. The electronic device of claim 1 wherein the processor is embedded with the electronic device.

5. The electronic device of claim 1 wherein the electronic device is in remote communication with the processor.

6. The electronic device of claim 1 wherein the user interaction information comprises one of a group, the group comprising: user's grip location, user's grip pressure and which I/O device the user is currently using.

7. The electronic device of claim 1 further comprising:
a set of touch sensors embedded along the housing and the touch sensors capable of detecting user interaction information.

8. The electronic device of claim 1 wherein the indications to deliver a haptic response comprise one of a group, the group comprising: operating system commands, user application commands, audio tracks, video/game playback and metadata.

9. The electronic device of claim 1 wherein the desired haptic response is associated with the currently executing application with which the electronic device is interacting.

10. The electronic device of claim 9 wherein the desired number of haptic elements to energize as a set of user interaction zones is capable of delivering the desired haptic response with a substantially minimal number of haptic elements.

11. The electronic device of claim 10 wherein the set of user interaction zones is dynamically created according to the currently executing application and current user interaction information.

12. A method comprising:
executing an application capable of employing haptic feedback;
determining a desired haptic response upon receipt of an indication to deliver a haptic response;
determining user interaction information; and
dynamically determining a set of haptic elements to energize with desired haptic response signals, based on the user interaction information, the set of energized haptic elements defining a set of user interaction zones.

13. The method of claim 12 wherein the method further comprising:
sending the desired haptic response signals to the electronic device remotely from a processor determining the desired haptic response signals.

14. The method of claim 12 wherein determining a desired haptic response upon receipt of an indication to deliver a haptic response further comprises receiving the indication from one of a group, the group comprising: operating system commands, user application commands, audio tracks, video/game playback and metadata.

15. The method of claim 14 wherein determining a desired haptic response upon receipt of an indication to deliver a haptic response further comprises automatically performing scene analysis in a video/game playback to determine whether a haptic response is desired.

16. The method of claim 12 wherein determining user interaction information further comprises determining a grip zone from one of a group, the group comprising: a set of touch sensors embedded in the electronic device and signals from an I/O device with which the user is interacting.

17. The method of claim 16 wherein dynamically determining a set of haptic elements to energize with desired haptic response signals further comprises determining a substantially minimal set of haptic elements that are proximal to user's grip zone.

18. A haptic system comprising:
two or more haptic elements;
a processor in communication with the haptic elements, the processor configured to:
receive user interaction information;
receive indications to deliver a haptic response;
determine a haptic response based upon the indications; and
determine a number of haptic elements to energize to provide the haptic response based upon the user interaction information and the desired number of haptic elements defining a set of user interaction zones to deliver the haptic response.

19. The haptic system of claim 18 wherein the haptic elements are individual addressable and are configured to provide multiple amplitudes of haptic feedback.

20. The electronic device of claim 18 wherein the set of user interaction zones are dynamically partitioned.
